(19) United States
(12) Patent Application Publication
(10) Pub. No.: US 2024/0330917 A1
(43) Pub. Date: Oct. 3, 2024

(54) CRYPTOGRAPHIC CONTRACT AND METHOD OF USE

(71) Applicant: Hathor Labs, George Town (KY)

(72) Inventor: Marcelo Salhab Brogliato, Frisco, TX (US)

(73) Assignee: Hathor Labs, George Town (KY)

(21) Appl. No.: 18/623,369

(22) Filed: Apr. 1, 2024

Related U.S. Application Data
(60) Provisional application No. 63/493,091, filed on Mar. 30, 2023.

(51) Int. Cl. G06Q 20/38; G06Q 20/40

(52) U.S. Cl. CPC G06Q 20/389; G06Q 20/401

(57) ABSTRACT

In variants, a blockchain method can include: receiving a transaction including a contract identifier, a method identifier, a set of method arguments, a set of input UTXOs, and a set of output UTXOs; evaluating logic for the identified method from the identified contract; and changing the blockchain state based on the evaluation.

### CROSS-REFERENCE TO RELATED APPLICATIONS

This application claims the benefit of U.S. Provisional Application No. 63/493,091 filed 30 Mar. 2023, each of which is incorporated in its entirety by this reference.

### TECHNICAL FIELD

This invention relates generally to the blockchain field, and more specifically to a new and useful cryptographic contract architecture in the blockchain field.

### BRIEF DESCRIPTION OF THE FIGURES

FIG. 1 is a schematic representation of a variant of the cryptographic contract.

FIG. 2 is a schematic representation of an example of a contract instance.

FIG. 3 is a schematic representation of an example blockchain, including a verification DAG and a fund DAG with the same transactions.

FIG. 4 is a schematic representation of a cryptographic network with a DAG of transactions and optionally a blockchain confirming transactions in the DAG.

FIG. 5 is a schematic representation of a blueprint-cryptographic contract relationship.

FIG. 6 is a schematic representation of an example transaction that calls a cryptographic contract.

FIG. 7 is a schematic representation of a set of blockchain nodes, each storing a network core (e.g., blockchain protocol) and a blockchain ledger, wherein the blockchain ledger is synchronized and collectively updated via consensus.

FIG. 8A is a schematic representation of an example of a transaction.

FIG. 8B is an illustrative example of a transaction to create a contract from a blueprint.

FIG. 9 is an illustrative example of related transactions, wherein child transactions spend outputs of parent transactions.

FIG. 10 is an illustrative example of executing a contract method.

FIG. 11 is an illustrative example of a chain of transactions associated with a contract and a set of user interactions with the contract.

FIG. 12 is a schematic representation of an example of executing a contract by referencing blueprint logic.

FIG. 13 is a schematic representation of a variant of the method.

FIG. 14 is an illustrative example of a blueprint.

### DETAILED DESCRIPTION

The following description of the embodiments of the invention is not intended to limit the invention to these embodiments, but rather to enable any person skilled in the art to make and use this invention.

### 1. Overview

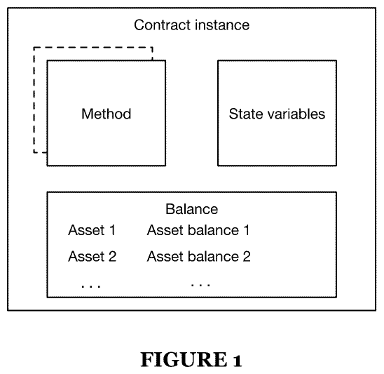

In variants, a cryptographic contract 100 can include: set of methods, a state, and/or a balance, or be otherwise defined (e.g., example shown in FIG. 1). The cryptographic contract (e.g., smart contract, contract, nanocontract, “nk”, etc.) functions to enable account-like interactions with a UTXO-based chain.

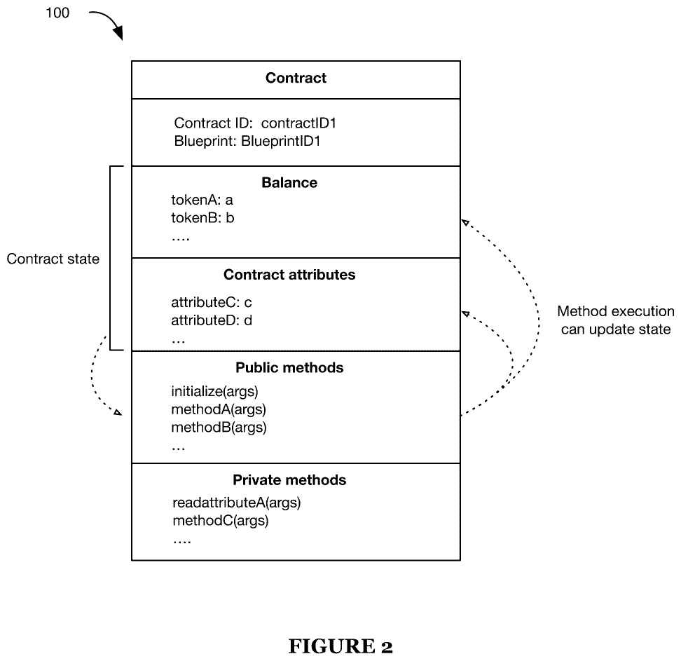

In an illustrative example, a UTXO blockchain can include a set of cryptographic contracts (“contracts”) within the chain of transaction verifications (e.g., a DAG of verifications), wherein each contract is associated with a contract identifier (e.g., a hash of the transaction that initialized the contract), a balance, a state, and a set of methods (e.g., example shown in FIG. 2). The balance, state, and set of methods can be stored by a set of nodes or peers in the blockchain ledger (e.g., in local node storage, or DAG of Transactions, or Chain of Blocks), be stored on-chain (e.g., by a set of node or peers, be stored as part of the chain state on the ledger, be stored by updating the contract balance stored by the transaction that created the contract, etc.), or be otherwise stored. The contract methods can be called by one or more blockchain transactions, wherein one or more nodes receiving the transaction can execute the method, update the contract balance and state (e.g., in local node storage) based on method execution, and optionally transfer tokens (e.g., UTXOs) identified in the transactions (e.g., during consensus). In examples, the transaction can be verified and added to the blockchain if the peers reach consensus (e.g., agree) upon the contract balance, state, transaction inputs (e.g., input UTXOs, transaction spent inputs, etc.), transaction outputs (e.g., output UTXOs), and/or other transaction information. In specific examples, each contract can be an instance of a blueprint (e.g., a contract blueprint), wherein the contract methods are the blueprint methods and a call to the contract method references the blueprint's method logic. The blueprint can be stored in the blockchain protocol that is stored by the node (e.g., by the blockchain core, by the blockchain code running on the node, etc.), be stored in the blockchain ledger, be stored on-chain, and/or otherwise stored.

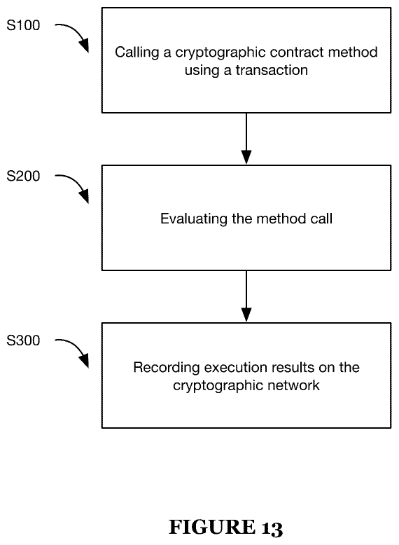

In variants, a method of using a cryptographic contract can include: calling a cryptographic contract method using a transaction S100; evaluating the method call S200; and recording method execution results on the cryptographic network S300, example shown in FIG. 13. In variants, the method can also include spending UTXO outputs; creating new UTXO outputs; depositing tokens into the contract; withdrawing tokens from the contract; and/or other contract or UTXO interactions. In examples, this can: update the cryptographic contract state (e.g., change the variable values), update the cryptographic contract balance (e.g., change the cryptographic contract's balance for one or more cryptographic asset types), connect the cryptographic contract to the newly-verified transaction, and/or otherwise update the cryptographic contract (e.g., during transaction verification, during transaction confirmation, etc.).

In an illustrative example, the method of using a cryptographic contract can include, at a node of the cryptographic network (e.g., blockchain): receiving a transaction including a contract identifier, a set of method identifiers, method arguments, input UTXOs (e.g., spending UTXOs), output UTXOs, and a cryptographic signature from the sending address (e.g., an authorized spender of the input UTXOs); optionally verifying the transaction and cryptographic signature; determining the logic for the identified method for the identified contract (e.g., from the blueprint, from the contract code, etc.); updating the contract balance and/or state (e.g., in local node storage) by executing the logic using the method arguments; optionally generating the output UTXOs (e.g., based on the contract balance and/or the input UTXOs); communicating the contract balance, contract state, and/or output UTXOs to peer nodes (e.g., updated blockchain state); and reaching consensus with the peer nodes on the contract balance, contract state, and/or output UTXO values, wherein the validated transaction (e.g., verified transaction) can be added to the chain of transaction validations (e.g., the blockchain, added as a vertex or node in the DAG of validations or DAG of verifications, etc.). In variants, the transaction can optionally include deposits into the contract and/or withdrawals from the contract, wherein transaction validation or confirmation can update the contract balance accordingly. In examples, method logic determination, method logic execution, output UTXO generation, communication of the chain state (e.g., contract balance, contract state, UTXO information, etc.), and reaching consensus can occur atomically (e.g., during a consensus period). In examples, tokens (e.g., cryptographic assets) can be sent to the contract. For example, the contract balance for a token type (e.g., native token, wrapped token, etc.) can be incremented by the token value held by one or more of the input UTXOs (e.g., without generating an output UTXO addressed to the contract or generating a special deposit output), such that the contract aggregates the tokens (e.g., without holding UTXOs). In an alternative examples, the transaction can output UTXOs addressed to the contract.

### 2. Technical Advantages

Variants of the technology can confer advantages over conventional systems.

First, UTXO-based blockchains lack a true, on-chain contract architecture. Conventionally, UXTO-based blockchains (e.g., Bitcoin) can approximate contracts by passing scripts within the transaction, and evaluating the script during transaction validation. However, this approach is not scalable and is stateless, making collaboration and usage over time difficult, if not impossible. To resolve these issues, some conventional systems (e.g., Lightning network for Bitcoin) implement contracts on a separate blockchain (a “layer 2” chain), which executes the contract logic, aggregates the transactions (e.g., including the input UTXOs and/or output UTXOs), and sends the aggregated transactions to the original blockchain (e.g., layer 1 blockchain) for confirmation and final asset transfer. However, this requires the users to trust both the layer 2 and layer 1 blockchains, verification and asset transfer takes longer (since the user needs to wait for confirmation by both the layer 2 and layer 2 blockchains), and the contracts are susceptible to more attacks (since the attack surface is doubled). Variants of this technology can resolve these issues by creating a cryptographic contract that stores the evaluation logic (e.g., methods) on chain or on the mining nodes, persists a state (e.g., is stateful), and aggregates funds across different transaction validations, all within the same chain (e.g., the layer 1 blockchain).

The contract state (e.g., state values, balance, etc.) can be stored: locally by the nodes, wherein the nodes can reach consensus on the state values; by updating the contract state values associated with the transaction (e.g., the calling transaction or the transaction creating the contract); or otherwise stored. For example, in variants, the cryptographic contract is created on a blockchain that includes a DAG (directed acyclic graph) of transaction verifications (DAG of verifications) and a DAG of transaction inputs (DAG of funds) (e.g., a separate DAG related by common transactions) and/or chain of blocks (e.g., verifying the transactions, a parent block, and/or transaction inputs), wherein the cryptographic contract is represented as a vertex in the DAG of verifications, and can be repeatedly referenced and updated by subsequent transactions. This enables the cryptographic contract to persist state and balance (e.g., using an account-based model), while still being compatible with UTXOs.

Second, variants of the technology can provide increased cryptographic contract security, lower code complexity, lower development cost, increase the auditability, increase the scalability, and/or solve the immutability dilemma by leveraging cryptographic contract blueprints 200 (e.g., contract templates). For example, cryptographic contracts can be instances of trusted blueprints (e.g., verified by a trusted party), which can reduce the adverse impact of bad logic and/or attack vectors. This can reduce conventional blockchain contract risks, such draining assets due to bad code and/or backchannels being left open. Variants of this technology also reduce the amount of data that is stored on-chain by storing the blueprints in the blockchain client, blockchain protocol, in a secondary network (e.g., peer to peer network), or an oracle, wherein the nodes can reference the blueprint logic when executing a contract method (e.g., a method of a blueprint instance). This can make consensus faster and cheaper by reducing the amount of information stored on chain. Variants of this technology can also enable the contract logic to be editable after initialization (e.g., by editing the blueprint logic, using a protocol update or by updating the oracle, etc.), since the contract logic (e.g., code) is not part of the blockchain itself, which can solve the smart contract immutability issue (e.g., to fix bugs, close security breaches, etc.). Alternatively, the contract logic can be stored on-chain (e.g., in the blockchain ledger, by the blockchain nodes, etc.), wherein the contract logic can be editable (e.g., by reaching consensus on the contract parameter values, by editing the contract information stored in a validated transaction, by calling an editing method, etc.) or uneditable. Variants of this technology can also enable codeless interaction with the blockchain. For example, this can enable users to generate contracts without coding by referencing blueprints using a drag-and-drop interface, a 1-click interface (e.g., wherein a transaction associated with the user and identifying the blueprint can be automatically generated and broadcast to the blockchain responsive to a single user action), an API interface, and/or other interfaces.

However, further advantages can be provided by the system and method disclosed herein.

### 3. System

The cryptographic contract 100 can be implemented on and/or used with one or more cryptographic networks 10. The cryptographic network 10 is preferably a Layer 1 blockchain (e.g., wherein the transactions reallocate native tokens to users), but can additionally or alternatively be a Layer 2 blockchain (e.g., without native token transfer) or any other suitable blockchain. The cryptographic network is preferably a hybridized blockchain, but can additionally or alternatively be a UTXO-based blockchain, an account-based blockchain, and/or be any other suitable blockchain.

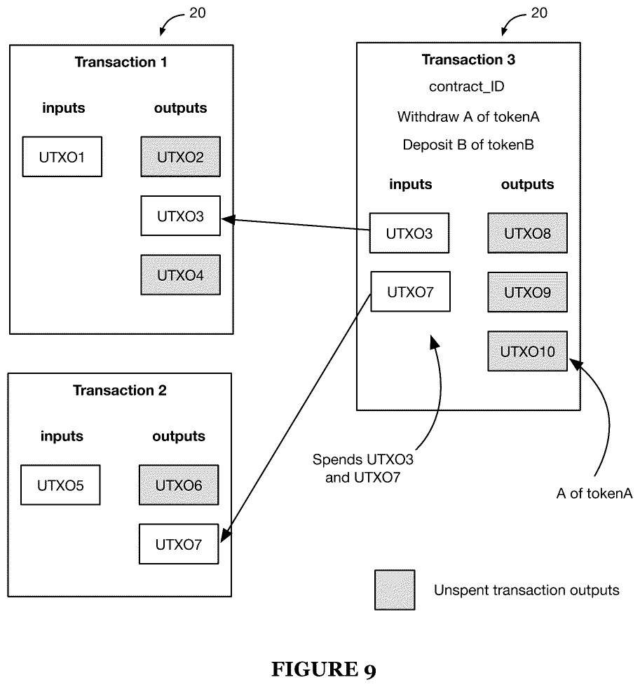

A UTXO-based blockchain can track individual assets (unspent transaction outputs or UTXOs). A UTXO can be output by a transaction, and can include a token amount (e.g., amount of Hathor, amount of Bitcoin, etc.), a UTXO identifier (e.g., hash of the transaction or transaction information), an owner address (e.g., address of the user that owns the UTXO), and/or other information. In examples, a UTXO can be owned by one or more users (e.g., when the protocol supports multisignature wallets), wherein the owner address can include one or more addresses corresponding to all or a subset of the users. A validated transaction in a UTXO-based blockchain can consume a set of input UTXOs (e.g., owned by the transaction sender) to generate a set of output UTXOs addressed to a set of recipient addresses and optionally the owner address (e.g., change), wherein the output UTXOs can be used as input UTXOs in subsequent transactions (e.g., example shown in FIG. 9). In an example, a UTXO-based blockchain can store a series of related transactions (e.g., parent-child transaction outputs) in the blockchain ledger. Unlike account-based blockchains, the cryptographic assets in a UTXO blockchain are not aggregated into a central balance in the user's account (e.g., a UTXO blockchain has individual UTXOs with addresses that are aggregated by the wallets, and does not directly update a user's account balance with each consensus). In an illustrative example, a cryptographic contract can aggregate funds in a UTXO blockchain when the UTXOs are addressed to the contract. However, UTXO blockchains can be otherwise configured.

An account-based blockchain can track and update a user's account balance within each block consensus (e.g., the blockchain peers agree on each address' updated account balance value), instead of tracking individual assets. In an example, an account-based blockchain can store a set of account states (e.g., token balances, attribute values, etc. for each account) in the blockchain ledger. In an illustrative example, a cryptographic contract can aggregate funds in an account-based blockchain when the cryptographic network peers (e.g., blockchain nodes) agree on the updated contract balance. However, account-based blockchains can be otherwise configured.

A hybridized blockchain (e.g., Hathor network) can include both UTXO and account-based attributes. The hybridized blockchain is preferably a UTXO-based blockchain with account-like features, but can additionally or alternatively be an account-based blockchain with UTXO-like features, or otherwise configured. For example, the hybridized blockchain can include a UTXO-based mechanism for asset tracking (e.g., track the individual assets -UTXOs-, instead of tracking account balances) and/or wallet bookkeeping, but include account-like tracking for contract balances. In an illustrative example, cryptographic network peers (e.g., blockchain nodes) can reach consensus on which transactions are valid, which output UTXOs should be generated (e.g., UTXO blockchain attributes), and the balance and/or contract attribute values for each contract (e.g., account blockchain attributes). However, hybridized blockchains can be otherwise configured.

The blockchain can be Turing incomplete, or be Turing complete. The blockchain can be incompatible with EVM (Ethereum virtual machine), or be compatible with EVM.

In variants, the cryptographic network 10 and/or the blockchain ledger can include one or more DAGs (directed acyclic graphs) of vertices. The DAG architecture is preferably implemented using UTXOs (e.g., is a UTXO-based blockchain), but can additionally or alternatively be an account-based blockchain. Each vertex can be a transaction, a block, a cryptographic contract, a UTXO, and/or be any other suitable data representation. The edges preferably represent validated connections between a child vertex and a parent vertex. For example, the edges can represent validated connections between a parent transaction and a child transaction (e.g., spending an UTXO output by the parent transaction, etc.). Each vertex can be connected to one or more parent vertices, and can be connected to one or more child vertices. The edges (e.g., connections) between parent and children vertices preferably do not change after confirmation (e.g., after a threshold number of validations have been performed), but can alternatively change (e.g., be removed). A vertex can be validated when the vertex's parents already exist and are valid, the timestamp is greater than the parent transactions, and any referenced vertices or funds are valid (e.g., the transaction's parents' funds are valid, the inputs are equal to or higher than the output funds, and the transaction inputs fulfill the scripts associated with the input UTXOs, such as verifying that the transaction inputs are signed by the same private key as that associated with the input UTXOs). Validating a vertex can generate an edge in the DAG connecting the new vertex to the parent vertex, and/or otherwise modify the DAG. A validated vertex's values preferably do not change, but can additionally or alternatively be editable over time. For example, the values for a validated transaction that created a contract do not change, but the contract parameter values (e.g., contract state, contract balance) can change.

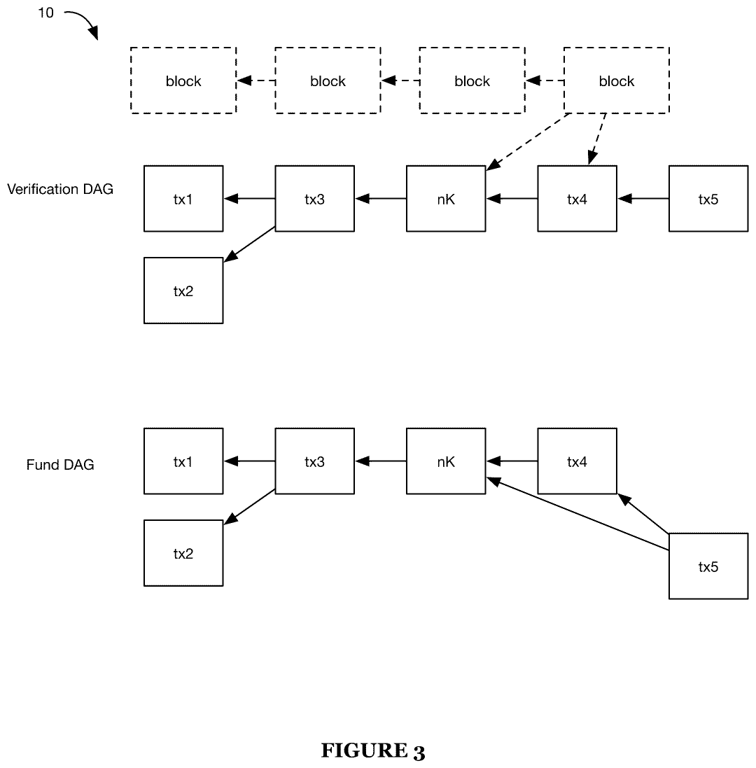

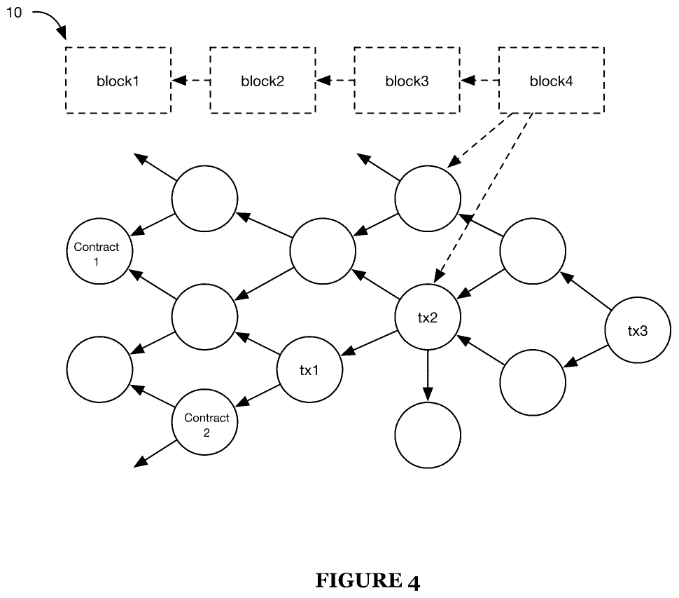

In variants, each vertex (e.g., transaction, block, etc.) is individually validated (e.g., examples shown in FIG. 3 and FIG. 4) and confirmed; alternatively, blocks of vertices (e.g., blocks of transactions) can be validated and confirmed together. When blocks of vertices are confirmed, child blocks can confirm a parent block and one or more transactions (e.g., example shown in FIG. 4). Each vertex can be validated based on proof of work, proof of stake, and/or otherwise validated. The amount of proof (work) needed to validate a vertex is preferably determined based on the weight of the vertex (e.g., the difficulty of mining the transaction), but can alternatively be the same for all vertices, or differ. The weight of a vertex can be determined based on the amount of cryptographic assets transferred, the vertex's size (e.g., in bytes), the actions being called by the transaction (e.g., digital asset transfer can have lower weight than digital asset creation), the blockchain's hash rate, whether an attack is occurring, and/or based on any other suitable set of parameters. Valid vertices can be confirmed after a threshold number of subsequent child vertices have been confirmed (e.g., after 6 subsequent generations have been confirmed), when the accumulated weight exceeds a threshold (e.g., determined based on the parameters above, a static value, etc.), and/or at any other suitable time. When a conflict arises, the vertex with the highest accumulated weight (e.g., aggregated over multiple validations by multiple miners), the higher hash value, and/or vertex satisfying any other suitable condition can be selected as the true vertex, and the other vertex can be discarded.

In variants, the set of DAGs can include: a DAG of verifications and a DAG of funds (e.g., example shown in FIG. 3), wherein the DAG of verifications can be related to the DAG of funds. However, the set of DAGs can include any other suitable DAG.

The DAG of verifications can represent a series of vertices (e.g., transactions, blocks, etc.), wherein each child vertex is connected to a parent vertex because the child vertex verified the parent vertex (e.g., example shown in FIG. 3). For example, when A is a parent of B, B checks that A is a valid vertex. In an example, the DAG of verifications can represent a graph of valid, related transactions.

The DAG of funds can represent a series of inputs and outputs, wherein each child vertex spends the funds from the parent vertex (e.g., example shown in FIG. 3). For example, when A is a parent of B (e.g., B has an input pointing to an output of A), B is spending an output of A. In an example, the DAG of funds can represent how the UTXOs are related (e.g., split and/or combined into output or child UTXOs).

The DAG of funds can be separate from but related to the DAG of verifications (e.g., via the transactions), or be the same. For example, the DAG of verifications can track which transactions are valid, while the DAG of funds tracks how the funds have been transferred and combined or separated.

In other variants, the cryptographic network 10 can include a DAG of transactions and a chain of blocks (e.g., blockchain), wherein child transactions in the DAG of transactions can validate the parent transactions, and each block can validate the parent block and a set of transactions within the DAG of transactions (e.g., example shown in FIG. 4).

In other variants, the cryptographic network can include a chain of blocks, wherein each block can verify a prior block, one or more transactions, and/or other blockchain information.

In these variants, validating a vertex can generate an edge in the DAG of verifications connecting the new vertex to the parent verification vertices, and can also generate an edge in the DAG of funds connecting the vertex to the parent fund vertices, wherein the parent verification vertices can be the same or different from the parent fund vertices.

However, the DAG-based cryptographic network can be otherwise constructed.

However, the cryptographic network can be otherwise structured.

The cryptographic network 10 is preferably managed by a set of nodes (e.g., peers, blockchain nodes, full nodes, cryptographic nodes, etc.). Each node can include a blockchain client executing a blockchain protocol on a computing system (e.g., including a processing system, memory, etc.), and/or include other components. The blockchain client and blockchain protocol are preferably the same for all nodes on the blockchain, but can additionally or alternatively be different. For example, the blockchain nodes can include full nodes, partial nodes, and/or other nodes. Each node can synchronize all or a portion of the blockchain from other nodes (e.g., using a flooding protocol, gossip protocol, etc.).

The cryptographic network is preferably used with a set of tokens, which can function as a base unit of cryptographic value. The tokens can be native tokens, custom tokens (e.g., generated using contracts, etc.), wrapped tokens (e.g., nonnative tokens that have been wrapped to be compatible with the cryptographic network's protocols, etc.), and/or other tokens. A UTXO can include an amount of a given token. Each UTXO preferably includes an amount of a single token type (e.g., asset, asset type), but can additionally or alternatively include amounts of multiple token types. However, UTXOs can be otherwise related to a token.

Cryptographic functionality on the blockchain can be enabled using a set of transactions 20 (e.g., blockchain transactions, cryptographic network transactions, etc.), wherein the functionality is implemented when the transaction is validated or confirmed. Cryptographic functionality can include: asset transfer (e.g., from a sender to a recipient), contract initialization, contract execution, token generation, and/or other functionality.

Transaction validation can include: validating the digital signatures of the inputs, validating the digital signature on the transaction (e.g., as being associated with the private key owning the inputs), validating that the inputs are at least as valuable as the outputs, validating that the inputs are not being double spent, and/or otherwise validated. Transaction confirmation can include using proof of work, proof of stake, proof of authority, and/or other proof mechanisms to agree on the next blockchain state (e.g., what UTXOs should be generated, the contract state, etc.). Transaction validation and/or confirmation can be performed by one or more blockchain nodes (e.g., a quorum of nodes, a majority of nodes, etc.). A transaction can be confirmed after a threshold number of validations, after a threshold accumulated weight has been reached for the transaction, after a threshold number of descendant generations have been validated, after a threshold number of peers has confirmed the transaction, and/or otherwise confirmed. In an illustrative example, a transaction can be sent to the blockchain by a user and received by a set of blockchain nodes, wherein the blockchain nodes can each validate the transaction and either cooperatively or independently confirm the transaction (e.g., via consensus). In a first example, the blockchain nodes can each independently confirm the transaction (e.g., confirming a block, accept a block, etc.), and can reach consensus on the block when a threshold number of subsequent blocks (e.g., after the given block) are confirmed. In a second example, the blockchain nodes can share proposed chain states and cooperatively agree on a final chain state. However, consensus can be otherwise reached. The transaction can be added to the cryptographic network (e.g., the DAG, the blockchain) after confirmation. However, the transaction can be otherwise added to the cryptographic network.

The transactions 20 can be generated by: blockchain users (e.g., user accounts, contract creators, etc.), oracles, other methods on the same or different cryptographic network, and/or other entities.

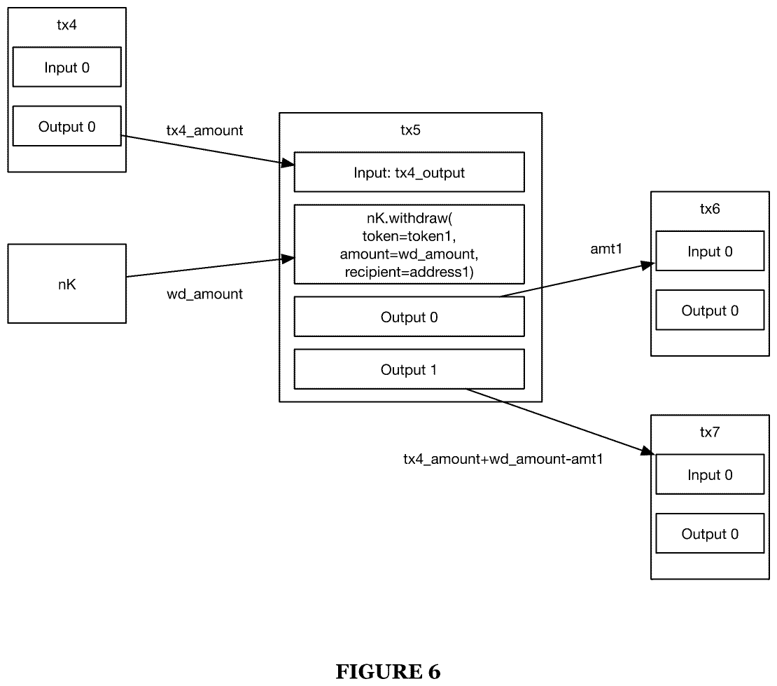

A transaction 20 on the cryptographic network 10 can include: a set of inputs (e.g., input UTXOs, input transaction outputs, etc.), a set of outputs (e.g., output UTXOs, output transaction outputs, unspent transactions, etc.), a set of parent vertices (e.g., validation parents; parent transactions; parent blocks; etc.), a set of auxiliary fields, a set of signatures (e.g., by one or more private keys associated with sender and/or the set of inputs), and/or any other suitable information (e.g., example shown in FIG. 6). The set of inputs and/or set of outputs can include: no values (e.g., no UTXOs), a single value (e.g., a single input UTXO, a single output UTXO, etc.), multiple values (e.g., multiple UTXOs for one or more token types, multitoken, etc.), and/or any other suitable number of values. The inputs can be linked to one or more output types (e.g., P2PKH output, P2SH output, etc.).

When the transaction 20 interacts with a cryptographic contract 100, the set of auxiliary fields can include: one or more cryptographic contract identifiers, a set of method calls, a set of method arguments, a caller identifier, a caller signature (e.g., generated using the calling user's private key), and/or any other suitable set of cryptographic contract information (e.g., example shown in FIG. 6). In this variant, the set of inputs and/or set of outputs can be related or unrelated to the contract call. For example, the transaction can call one or more contract methods and, separately, transfer a set of input UTXOs to one or more recipients using a set of UTXOs. In another example, the contract method called by the transaction can consume one or more of the set of input UTXOs (e.g., a “deposit” or “exchange” method), and/or generate one or more of the output UTXOs (e.g., from the contract's balance). In this example, the difference between the inputs and the outputs (e.g., when the inputs are higher than the outputs) can be aggregated at the cryptographic contract, and/or otherwise handled; alternatively, the contract balance can be otherwise changed.

In a specific example, all transactions associated with a contract (e.g., calling the contract) can form an ordered list (e.g., ordered list of contract executions). The first transaction can be the transaction that created the contract, and the following transactions can include transactions that modified (or failed to modify) the contract state. In examples, the set of contract data stored by the blockchain can include the set of transactions associated with the contract (e.g., ordered list of transactions) and the contract state. However, the transactions 20 can be otherwise related to the contract 100.

However, any other suitable blockchain can be used.

The cryptographic contract 100 functions to enable the execution of distributed and decentralized applications in a blockchain ledger (e.g., in a UTXO-based blockchain).

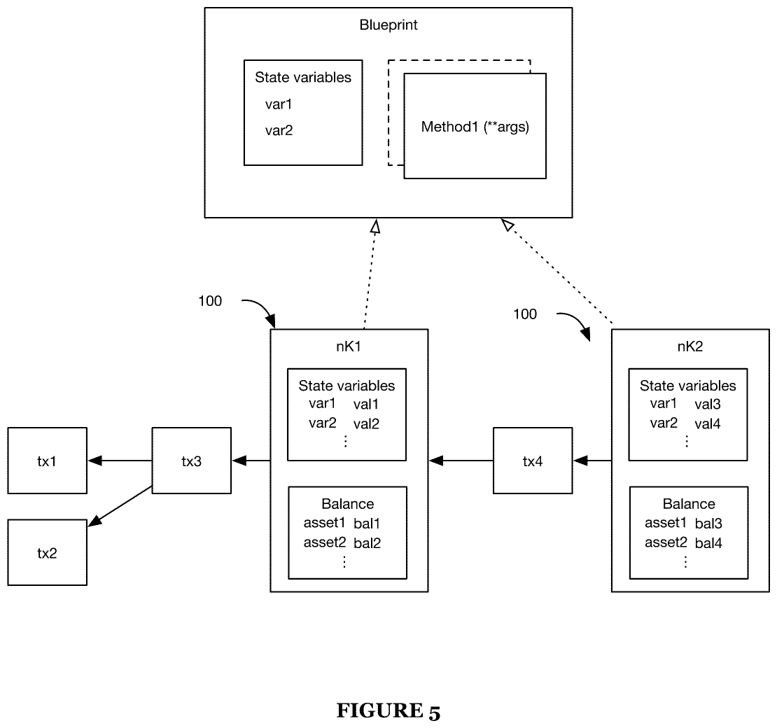

The blockchain can include one or more cryptographic contracts of the same or different type (e.g., example shown in FIG. 5). Different cryptographic contracts are preferably independent and distinct from each other (e.g., have their own isolated state; can only change their own state and balance; cannot directly change another cryptographic contract's state and balance; etc.), but can alternatively share a common state, a common balance, and/or any other suitable parameter. Different cryptographic contracts can interact with each other via the other cryptographic contract's methods, but can otherwise interact with each other. The cryptographic contracts available on the blockchain can be listed in a registry or otherwise identified.

The cryptographic contract is preferably on the blockchain (e.g., created in the blockchain), but can alternatively be an off-chain contract. The cryptographic contract is preferably native to the blockchain and on the same blockchain as the native tokens (e.g., on the Layer 1 chain, on the same chain as the UTXO, etc.), but can additionally or alternatively be on a different blockchain (e.g., on a Layer 2 chain). In variants, having the contract native to the blockchain can mitigate the risk of bugs and security issues, or confer other benefits. The cryptographic contract is preferably a vertex in the DAG of transactions or the DAG of verifications, but can be a transaction, an address or wallet, a UTXO, and/or otherwise represented. In an example, the cryptographic contract can be connected to subsequent transactions in the validation DAG, and be connected to multiple subsequent transactions (e.g., that interact with the cryptographic contract) in the fund DAG.

The cryptographic contract can be identified by a contract identifier. The contract identifier can be: a vertex identifier (e.g., a transaction identifier), a hash (e.g., hash of the transaction that created the contract), an address (e.g., associated with the contract creator's private key, associated with an authorized user's private key, associated with the creation address, a randomly-generated address, an incrementally assigned address, etc.; a UTXO address; etc.), a semantic name, and/or otherwise identified. In an example, the contract address can include a DAG contract address, wherein the address can be a hash of the transaction that initialized the contract and/or otherwise determined.

Each cryptographic contract can include: a set of states, a balance, a set of methods, and/or any other suitable component.

The ability to change the cryptographic contract balance, change the contract state, make all or a portion of the contract method calls, and/or otherwise interact with the contract can be limited (e.g., to a set of authorized users, a set of authorized private keys, etc.) or unlimited. Authorized users can be identified by the contract (e.g., wherein a public key for the authorized users can be stored as a contract attribute and used for call authorization), by the transaction that created the contract, and/or otherwise identified. For example, the blockchain nodes and/or the cryptographic contract can verify that a transaction modifying the cryptographic contract balance is signed by a specific private key (e.g., paired with the public key stored by the contract) before permitting a balance change. In variants, balance change permissions can be specified when initializing the cryptographic contract, be adjusted by a contract administrator (e.g., the account initializing the cryptographic contract, etc.) and/or otherwise determined.

The set of states (contract state) function to persist a cryptographic contract state over time (e.g., over multiple confirmations, blocks, etc.). The cryptographic contract state is preferably dynamic and can be changed (e.g., by subsequent transactions); alternatively, the cryptographic contract state can be static. The state can be defined by a set of values for a set of variables (e.g., typed variables), a set of attributes, or otherwise defined. The contract state can include: the contract balance, a counter, method argument values, authorized user information (e.g., public key), oracle identifiers (e.g., identifying an oracle to pull data from), secondary contract identifiers (e.g., identifying other contracts to call methods from), endpoint identifiers (e.g., API identifiers, etc.), custom method logic, and/or other attributes. Alternatively, the contract state can exclude the contract balance. The cryptographic contract variable values can be: default values, be determined by the method, be set by a transaction, be set by an oracle (e.g., an off-chain data source), and/or otherwise determined. The ability to change the values of one or more cryptographic contract state variables can be limited (e.g., to a set of authorized users, a set of authorized private keys, etc.) or unlimited. For example, the cryptographic contract can verify that a transaction changing a predetermined variable's value is signed by a specific private key before permitting the variable value change. In variants, the variable change permissions can be specified when initializing the cryptographic contract, be adjusted by a contract administrator (e.g., the account initializing the cryptographic contract, etc.) and/or otherwise determined. However, the contract state can be otherwise managed. The contract state (e.g., attribute values, variable values) can be used in the contract's methods (e.g., as method arguments), be changed by the contract's methods, and/or be otherwise used.

The contract state is preferably persisted in storage (e.g., snapshottable), but can additionally or alternatively be otherwise stored. The contract state is preferably stored on-chain, but can alternatively be stored off-chain. In a first variant, the contract state can be stored on-chain, in the blockchain ledger, as a set of values associated with the contract address. In a second variant, the contract state can be stored with the transaction that created the contract, wherein the transaction values are updated by subsequent transactions. In a third variant, the contract state can be collectively stored by the chain of transactions. In this variant, the contract state is not explicitly stored, but can be computed from a series of state changes implemented by the chain of confirmed transactions. In a fourth variant, the contract state can be stored by an off-chain entity (e.g., oracle). However, the contract state can be otherwise stored.

Each contract can access and change its own state (e.g., the contract methods can read and/or write the contract state). Each contract preferably is unable to directly access and/or change other contracts' state (e.g., without calling a method), but can additionally or alternatively directly access and/or change other contracts' states (e.g., child contracts, sub-contracts, contracts managed by a parent contract, etc.).

The balance functions to track the cryptographic assets (e.g., funds) that are associated with the cryptographic contract. Each cryptographic contract can store one or more cryptographic assets (e.g., concurrently). For example, the cryptographic contract can maintain a multitoken balance. The different cryptographic assets can be wrapped tokens, native tokens, and/or any other suitable cryptographic asset. Multiple cryptographic assets (e.g., ETH, HTR, LTC, etc.) can be deposited and/or withdrawn from the cryptographic contract in a single transaction; alternatively, depositing and/or withdrawing different cryptographic assets can be split across different transactions. In a first variant, the contract balance is updated by updating the values (e.g., balance) associated with each token type. In this variant, the contract can aggregate assets in a UTXO-based blockchain (e.g., without holding UTXO). In a second variant, the contract balance is updated by generating UTXOs addressed to the contract. However, the contract balance can be otherwise updated. The balance is preferably stored in the blockchain data (e.g., on chain), but can additionally or alternatively be stored off chain (e.g., by a node, etc.).

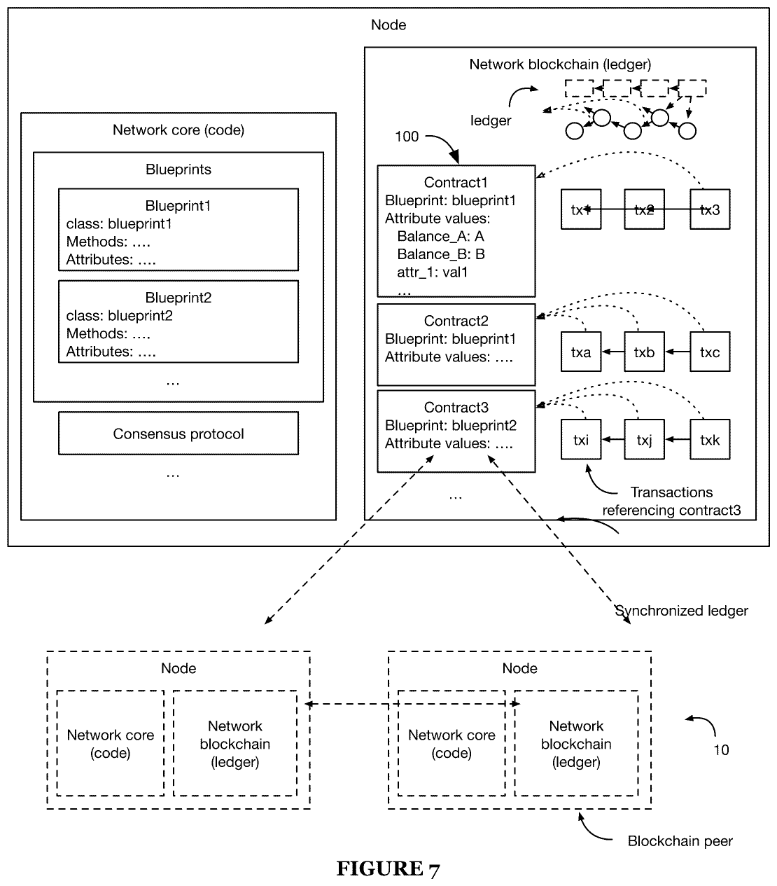

The cryptographic contract preferably stores the cryptographic assets itself (e.g., example shown in FIG. 1 and FIG. 5), but can alternatively store the value of the cryptographic assets (e.g., as a state variable), wherein the cryptographic assets are stored by a set of transactions (e.g., a set of output transactions, input transactions, a wallet, etc.). The cryptographic contract preferably accumulates the cryptographic assets (e.g., pools the assets), such that newly-deposited cryptographic assets are combined with previously-deposited cryptographic assets (e.g., example shown in FIG. 7). In variants, the cryptographic contract can do this because of the split-representation nature of the blockchain (e.g., the fund DAG is separate from the verification DAG, example shown in FIG. 3 and FIG. 7)). For example, a transaction depositing or withdrawing cryptographic assets from the cryptographic contract can be a direct or indirect descendant vertex of the cryptographic contract vertex in the verification DAG, but be a direct child vertex of the cryptographic contract in the fund DAG (e.g., wherein the transaction assigns deposited cryptographic assets to the cryptographic contract's vertex identifier).

Cryptographic contracts preferably do not have UTXOs (e.g., wherein the contract state is stored in association with a contract address, example shown in FIG. 7), but can alternatively have or be a UTXO. In an illustrative example, Alice has 1,000 HTR split into four independent UTXOs (e.g., wherein each UTXO can be spent independent of the others). To spend a certain amount of HTR, Alice can reference one or more of the UTXOs as inputs to a transaction, specify the amount of HTR in a UTXO output to be sent to a recipient, and optionally specify the amount of HTR in a UTXO output to return to herself. However, when Alice sends 1,000 HTR to a cryptographic contract, her deposit is combined with whatever has been previously deposited in that cryptographic contract.

The set of methods can define a set of logic, which can determine whether blockchain actions specified in the method are executed. Example blockchain actions can include: depositing funds into the cryptographic contract, withdrawing funds from the cryptographic contract, changing the cryptographic contract state (e.g., changing a variable value), calling a method on another cryptographic contract, creating a new token, and/or other actions. For example, if Alice wants to deposit 1000 HTR into the cryptographic contract, she will call a method that determines whether she can make the deposit. Each method can be called one or more times, by one or more transactions, in one or more confirmation epochs. Each method is preferably deterministic (e.g., to enable multiple miners to arrive at the same result during consensus), but can alternatively be probabilistic. However, the set of methods can be otherwise used and/or defined.

The method logic can include blueprint logic (e.g., logic from a contract template 200), custom logic, a combination thereof, and/or other logic. When the method logic is blueprint logic, the contract can: include a copy of the blueprint method logic, include a reference to the blueprint method logic (e.g., without duplicating the blueprint method logic), be an instance of the blueprint, and/or otherwise reference the blueprint logic. The method logic is preferably stored by and/or accessible by each blockchain node, but can be otherwise stored. The method logic is preferably not editable after contract creation, but can alternatively be editable after contract creation (e.g., by editing the blueprint that the contract references, by calling a logic edit method on the contract, etc.).

The method logic can be stored on-chain, on-network, off-chain, and/or otherwise stored.

In a first variant, the method logic is stored on-chain. Examples of on-chain storage can include storing the method logic as part of a transaction (e.g., in the transaction attribute values) and/or as part of the blockchain ledger, wherein the transaction is referenced when executing the contract methods.

In a second variant, the method logic is stored on-network. Examples of on-network storage can include storing the method logic in: the blockchain protocol (e.g., example shown in FIG. 7), in the blockchain client executing the protocol on the node, in the node (e.g., in local memory) (e.g., example shown in FIG. 7), and/or otherwise storing the method logic using the nodes forming the blockchain network but not in the blockchain data itself. In this variant, the node memory or other non-ledger blockchain storage can be referenced when executing the contract methods.

In a third variant, the method logic is stored off-chain. Examples of off-chain storage can include storing the method logic in an oracle, on another chain, on the nodes, and/or on other off-chain storage. In this variant, the off-chain storage is referenced when executing the contract methods.

However, the method logic can be otherwise stored.

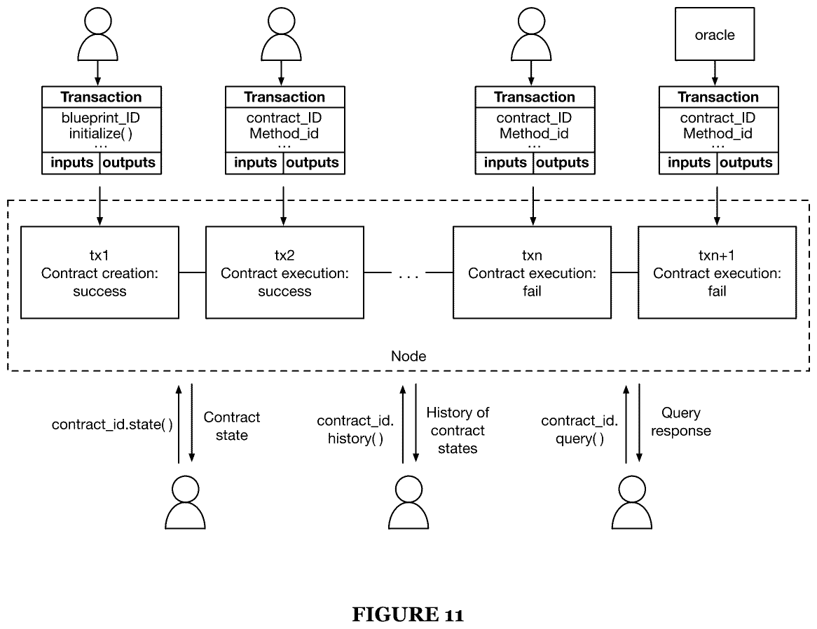

In variants, the contract methods can include private methods and public methods. Private methods can be read-only by users (e.g., example shown in FIG. 11), and/or can only be called by other methods of the contract. In specific examples, private methods can be prohibited from changing the contract state; alternatively, private methods can change the contract state. Public methods can enable users to read and/or write to the contract, such that the user can change the contract state. However, the contract methods can include any other suitable set of methods.

The available methods, states (e.g., variables, attributes, etc.), and/or other parameters of the cryptographic contract can be defined by: a blueprint, a script (e.g., in a transaction, a transaction output, a UTXO, etc.), and/or otherwise defined.

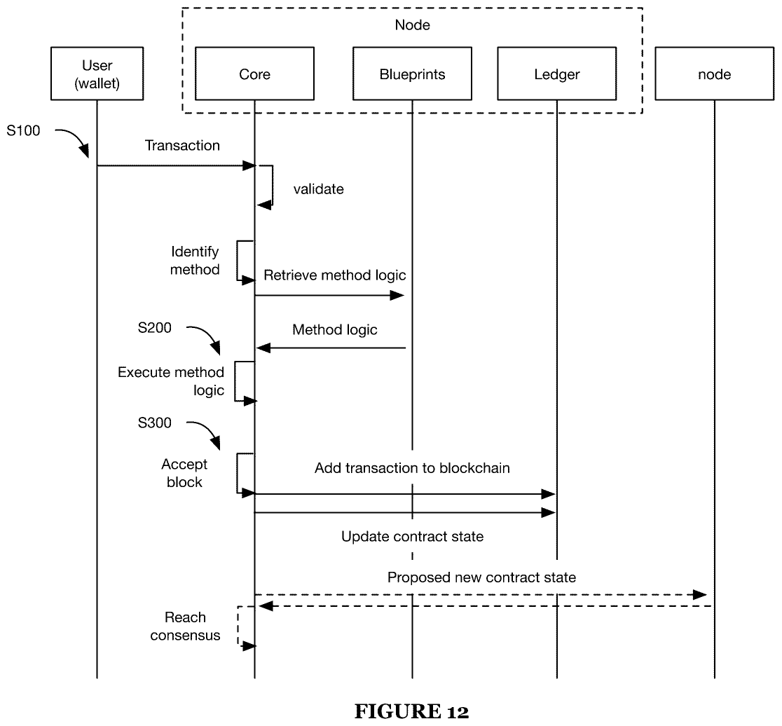

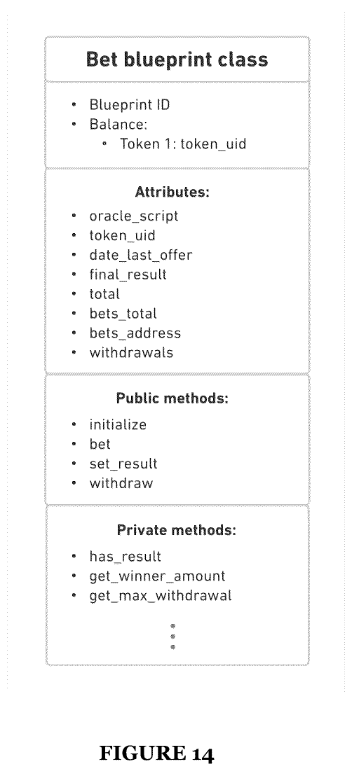

In a first variant, the cryptographic contract parameters can be defined by a blueprint 200 (e.g., examples shown in FIG. 5, FIG. 7, and FIG. 14), wherein the cryptographic contract is an instance of the blueprint. In examples, this can enable users to create smart contracts without needing to develop their source code (e.g., without coding, without an additional audit per contract, etc.), in an easy and rapid manner. In illustrative examples, a blueprint can include source code (e.g., function as a contract class) that models a general category of contract use cases, and serves as a template for creating a nano contract. Each blueprint can be associated with one or more cryptographic contracts (e.g., blueprint instances). Each contract is preferably associated with a single blueprint, but can additionally or alternatively be associated with multiple blueprints. Each contract 100 associated with the blueprint 200 can inherit the blueprint's information (e.g., attributes, methods, etc.), copy the blueprint's information, reference the blueprint's information, and/or otherwise use the blueprint's information. Each blueprint can be identified by: a blueprint name, a blockchain address, a transaction identifier, and/or any other suitable identifier. The blueprint 200 can define: the method logic, the state variables (e.g., contract attributes), optionally define the state variable values, and/or define any other suitable cryptographic contract parameter. The blueprint 200 is preferably stateless (e.g., does not include state variable values), but can alternatively be stateful. The cryptographic network 10 can be associated with one or more blueprints (e.g., a set of blueprints, a catalog of blueprints, etc.). The blueprints 200 can be stored: on-chain, on-network, on a blockchain node (e.g., on the hardware, by the client, by the protocol, etc.), off chain (e.g., be referenced by the cryptographic contract or transaction during validation; stored on an oracle; etc.), and/or otherwise stored. The blueprints 200 can be authored by a blockchain entity (e.g., with administrative or oversight permissions over the blockchain itself), an author, and/or by any other suitable user. The blueprints can be verified or signed by the blockchain entity before cryptographic contract instances can be generated; alternatively, the blueprints can be used without verification. In a first embodiment, each cryptographic contract is a copy of the blueprint. In a second embodiment, each cryptographic contract references the method logic in the associated blueprint (e.g., using a static URI, blockchain address, transaction identifier, etc.), example shown in FIG. 12. This second embodiment can: reduce the amount of redundant information that is stored on-chain, increase the cryptographic contract trust and/or security (e.g., only the blueprint needs to be trusted, not the cryptographic contract), dynamically update all related cryptographic contracts (e.g., by updating the blueprint), and/or confer other benefits. However, the blueprint can be otherwise used.

In a second variant, the cryptographic contract can be defined by a script (e.g., within a transaction). In this variant, the script can be stored with the transaction data in the cryptographic network, wherein the script is referenced when the contract is called.

However, the cryptographic contract can be otherwise defined.

All or parts of the cryptographic contract 100 are preferably stored on-chain (e.g., in the blockchain ledger, as part of a transaction or block, etc.), but can additionally or alternatively be stored on-network (e.g., decentralized, wherein every peer stores a version of the cryptographic contract's current state), off-chain (e.g., by an oracle, etc.), and/or otherwise stored. In a first example, the cryptographic contract methods, states, and balance can be stored on chain. In a second example, the cryptographic contract states and balance can be stored on-chain, while the cryptographic contract methods (e.g., the logic) can be stored on-network (e.g., by the blockchain nodes) or off-chain (e.g., by the blockchain nodes; in the node memory; by an oracle; etc.). However, the cryptographic contract information can be otherwise stored. The cryptographic contract is preferably stored in a manner that can be snapshotted (e.g., for recovery, reoganizations, etc.); alternatively, the cryptographic contract cannot be snapshotted.

The cryptographic contract 100 is preferably executed on-chain (e.g., the method logic is evaluated on-chain, by the miners, etc.), but can alternatively be executed off chain. Cryptographic contract execution is preferably distributed (e.g., all or a threshold proportion of miners or peers in the blockchain executes the cryptographic contract calls in the transactions), but can alternatively be centralized. Cryptographic contract execution is preferably deterministic (e.g., to enable multiple miners to arrive at the same result during consensus), but can alternatively be probabilistic.

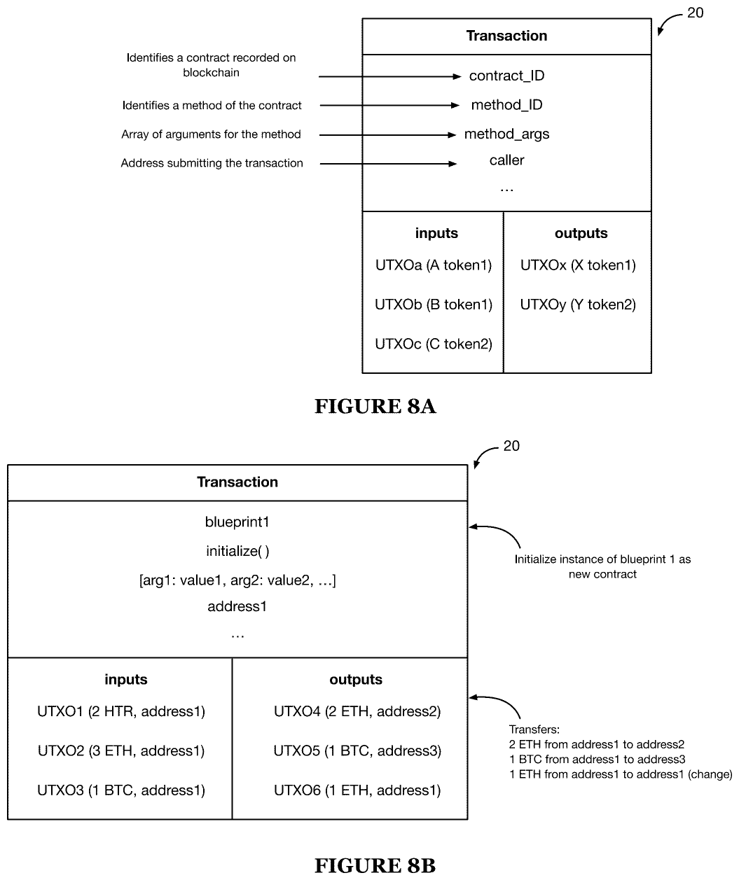

The cryptographic contract 100 is preferably initialized on-chain, but can additionally or alternatively be initialized off chain. The cryptographic contract is preferably initialized by a transaction (e.g., within the blockchain ledger), but can alternatively be otherwise initialized. In a first example, the cryptographic contract can be initialized by a transaction that calls an initialization method on a blueprint (e.g., example shown in FIG. 11), wherein execution of the initialization method (e.g., via blockchain consensus) generates a new contract as an instance of the blueprint. The transaction can optionally specify contract attribute values and/or other contract information, wherein the contract can be initialized using the contract information. In an illustrative example, the transaction can include: a blueprint identifier for the blueprint, a call to the initialization method in the blueprint (e.g., “initialize( )”, a set of method arguments (e.g., to set the contract attribute values), and/or any other suitable information, wherein a contract can be initialized as an instance of the blueprint with the attribute values once the transaction is confirmed (e.g., example shown in FIG. 8B). In a second example, the cryptographic contract can be initialized when a transaction including the contract script validated and confirmed by the blockchain peers (e.g., via blockchain consensus). However, the cryptographic contract can be otherwise initialized.

Cryptographic contract initialization is preferably verified in a similar manner as a transaction and/or is the same as a transaction verification, wherein the cryptographic contract forms a vertex in the verification DAG, and optionally forms a vertex in the fund DAG (e.g., when the cryptographic contract is funded during initialization). However, the cryptographic contract can be otherwise initialized.

After a cryptographic contract 100 is initialized, blockchain users (e.g., blockchain accounts, wallets, addresses, etc.) can interact with the contract by calling methods and, optionally, depositing tokens into the cryptographic contract or withdrawing tokens from the cryptographic contract. One or more deposits and withdrawals can happen in a single interaction.

Cryptographic contract 100 interaction (e.g., method execution) is preferably verified in a similar manner as a transaction (e.g., particularly when the transactions call the cryptographic contract) and/or is verified as a transaction, but can be otherwise verified. Cryptographic contract interactions can be verified when the transaction is received by the blockchain (e.g., the blockchain nodes), when the transaction is received at the mempool, when the transaction is confirmed, and/or at any other suitable time. Valid cryptographic contract interactions are preferably confirmed by miners when confirming the transaction calling the cryptographic contract, but can be otherwise confirmed. Cryptographic contract interactions can be considered valid when: the interaction calls a method of the cryptographic contract, method evaluation results in a valid result, the input UTXOs referenced in the method call are valid transactions, are funded (e.g., have at least the output amount), and are not double-spent, and/or when any other suitable set of conditions are met. The fee for cryptographic contract interaction can be paid by: the transaction sender (e.g., from the input UTXOs), the contract (e.g., wherein the fee is paid out of the contract balance), and/or otherwise paid.

Blockchain users preferably interact with the cryptographic contracts via a set of transactions 20, but can alternatively query the contract information stored on the node (e.g., read contract information off the node, example shown in FIG. 11), and/or otherwise interact with the cryptographic contracts. The transaction 20 is preferably an Li transaction (e.g., on the Li network), but can additionally or alternatively be a L2 transaction (e.g., on an L2 network separate from the Li network) and/or be any other suitable transaction. A transaction 20 can include: one or more contract identifiers, one or more method identifiers for a contract (e.g., one or more method calls), and a set of method arguments (e.g., argument values) for the method calls (e.g., example shown in FIG. 6). The transaction 20 can optionally include a set of UTXO inputs (e.g., including none or one or more UTXOs) and a set of UTXO outputs (e.g., including none or one or more UTXOs), examples shown in FIG. 8A and FIG. 9. The input and/or output UTXOs can be related to the method call (e.g., consumed or generated via the method call) or unrelated to the method call (e.g., wherein the transaction generates the output UTXOs based on the input UTXOs, independent of the method call). For example, contract method execution can generate output UTXOs addressed to a set of recipients, wherein transaction confirmation can transfer the UTXO value to the recipients. In variants, this can be done without aggregating multiple transactions and sending the transactions to a different chain for asset transfer. In another example, when the total input UTXOs differ from the total output UTXOs in a transaction, the difference can be aggregated within (e.g., deposited into) or drawn from (e.g., withdrawn from) the contract balance. Alternatively, the transaction can fail, or be otherwise managed. The transaction can optionally include a signature of the user calling the method (e.g., user associated with the contract, user associated with the input UTXOs, any user, etc.). Execution of the methods called in a given transaction 20 is preferably atomic, such that all calls in the transaction fail or succeed together (e.g., example shown in FIG. 11), but can alternatively be independent, such that only a portion of the transaction is validated or confirmed. Execution of the method and UTXO transfer in a given transaction is preferably atomic, such that the calls and the asset transfer fail or succeed together, but can additionally or alternatively be independent.

In an example, transactions 20 that interact with the contracts can be a hybrid of UTXO and account-based blockchain models, and can be constructed in a similar manner to UTXO models, but also reference (e.g., point to) a cryptographic contract, identify a method to be called, and pass the arguments to the identified method. In an illustrative example, a single transaction might be depositing 25 HTR and 6 ETH, and withdrawing 1 NFT from a cryptographic contract. The called method will determine whether the requested deposits and withdrawals are authorized. If they are not authorized, the whole execution will fail, and the contract's state and balance will not be affected.

Multiple transactions 20 can contemporaneously interact with the same contract (e.g., at the same time, in the same block, etc.). The multiple transactions are preferably executed serially, but can alternatively be executed concurrently (e.g., in parallel), randomly executed, and/or executed in any other suitable order. The order of transaction execution can be determined based on: the relative accumulated weight of the transactions (e.g., how deep the transaction is within the DAG of transactions, how deep the transaction is within the DAG of verifications, etc.), wherein the highest accumulated weight transaction is executed first; by the transaction hash (e.g., wherein the hash can be generated based on a timestamp or other transaction ordering mechanism); based on the timestamp (e.g., of transaction receipt on the blockchain); by the amount of work or stake that confirmed or is needed to the transaction; and/or otherwise determined. Execution of different transactions is preferably independent (e.g., one failed transaction does not fail all the transactions), but can additionally or alternatively be atomic.

However, the cryptographic contracts can be otherwise configured.

### 4. Method

In variants, the method for cryptographic contract operation can include: calling a cryptographic contract method using a transaction S100; evaluating the method call S200; and recording method execution results on the cryptographic network S300, example shown in FIG. 13. The method functions to enable decentralized, on-chain application execution.

All or portions of the method can be performed by: a user (e.g., a blockchain account, a wallet, etc.), blockchain nodes, an off-chain entity (e.g., a cloud computing system, etc.), and/or any other suitable system or entity. All or portions of the method can be performed: once, repeatedly, and/or any other suitable number of times for each transaction instance and/or multiple transaction instances.

Calling a cryptographic contract method using a transaction S100 functions to interact with the cryptographic contract. The transaction can be generated by a user (e.g., account, wallet, etc.), an offchain system (e.g., an off-chain application calling the on-chain cryptographic contract), an on-chain system (e.g., another cryptographic contract, etc.), and/or by any other suitable system. The transaction can be generated by a wallet that is different from the wallet that created the contract, or be generated by the same wallet. The transaction can include: a set of inputs (e.g., input UTXOs), a set of outputs (e.g., output UTXOs), a set of parents (e.g., validation parents, transactions that create the input UTXOs, etc.), one or more contract identifiers, a set of method calls, a set of method arguments, sender information (e.g., sender identifier, sender address, sender signature, etc.), and/or any other suitable information (e.g., examples shown in FIG. 6 and FIG. 8A). The transaction is preferably signed by one or more private keys, but can alternatively be unsigned or otherwise signed. The private key is preferably the one that is associated with the set of inputs (e.g., a private key associated with the address that the inputs were sent to), but can alternatively be any other suitable private key. The transaction is preferably broadcast to the blockchain to call the contract method; alternatively, the transaction can be sent to (e.g., received by) one or more blockchain nodes (e.g., to the client, to a different process executing in the blockchain node, etc.), and/or be otherwise called.

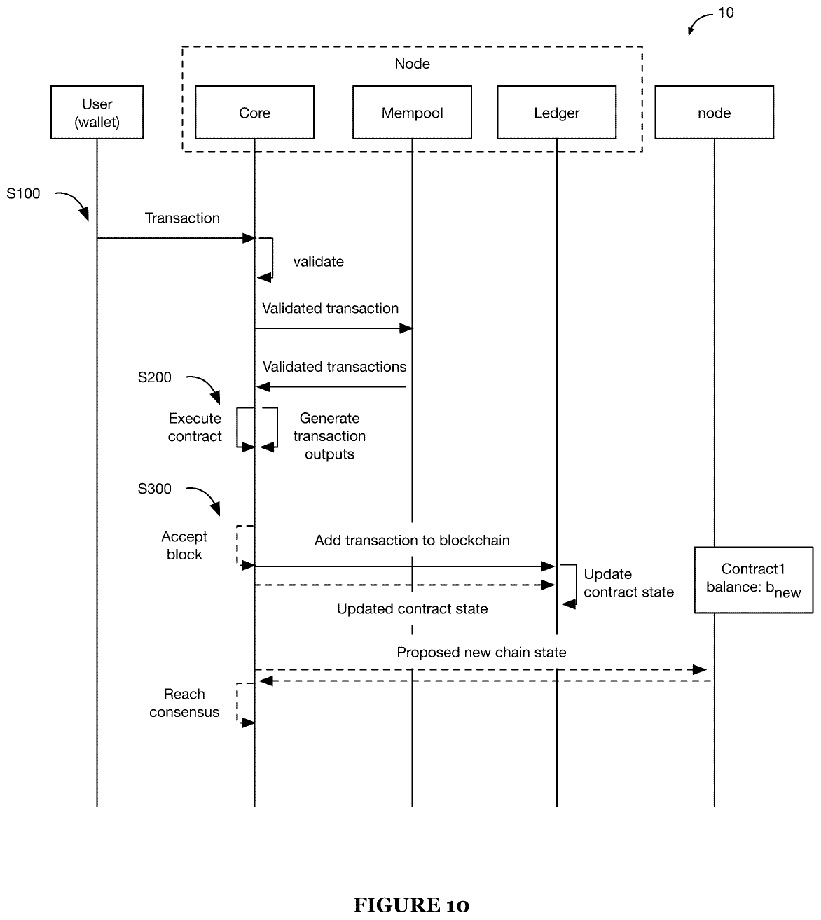

Evaluating the method call S200 functions to execute the called method or fail all or part of the transaction (e.g., example shown in FIG. 10). The method call is preferably evaluated by the blockchain, more preferably by the blockchain nodes (e.g., the miners, a threshold proportion of nodes, etc.), but can be otherwise evaluated. The method call can be performed: after transaction validation, during transaction validation, during transaction confirmation, and/or at any other suitable time.

Evaluating the method call S200 can include: validating the transaction and executing the called methods using the set of arguments. However, the method call can be otherwise validated. Transaction validation can include: validating the digital signatures of the inputs, validating the digital signature on the transaction, validating that the inputs are at least as valuable as the outputs (e.g., the input UTXOs are equal to or higher than the output UTXOs; that the input UTXOs and starting contract balance is equal to or higher than the output UTXOs and final contract balance; etc.), and/or otherwise validated. The called method can be executed after the transaction is considered valid, or be executed as part of validating the transaction. Executing the method can include: determining the method logic, evaluating the method, optionally performing a cryptographic contract action (e.g., based on method evaluation), and optionally failing all or a portion of the transaction when the method call fails. Determining the method logic can include retrieving the method logic from: the contract (e.g., determining the contract logic associated with the contract identifier from the blockchain ledger), the transaction that initialized the contract, the blueprint associated with the cryptographic contract (e.g., example shown in FIG. 11), logic storage (e.g., on the blockchain client, from off-chain storage, from local node storage, etc.), and/or otherwise determining the method logic.

Evaluating the method S200 can include executing the method logic using the argument values, the contract state, the input UTXO information, the output UTXO information, and/or other information. Performing a cryptographic contract action can include: updating the state variable values based on the method execution; updating the balance or aggregating cryptographic assets in the cryptographic contract (e.g., based on the method logic); transferring cryptographic assets to an address (e.g., specified in the transaction, hardcoded into the cryptographic contract, etc.), such as by generating a UTXO with the address as the recipient; calling a method on another cryptographic contract (e.g., passing state variable values, calculated variable values, transaction-specified argument values, and/or other values as argument values); and/or other actions. The cryptographic action can be performed as part of method evaluation, or be performed after. Method evaluation preferably generates a set of proposed contract states and does not change the contract state recorded on the blockchain (e.g., wherein the recorded contract state is not changed until the nodes reach consensus on the set of proposed contract states), but can alternatively change the contract state.

In variants, when multiple transactions call the same cryptographic contract at the same time, the method can optionally include ordering the transactions and executing the transactions in order. This can be useful because the transaction execution order determines whether the cryptographic contract has sufficient funds to fund the next transaction's method call. The transaction order can be determined based on: the transaction's accumulated weight (e.g., how many times the transaction has been validated by the miners and how much weight or work is required for each validation instance, etc.), wherein the transactions are ordered in order of decreasing accumulated weight; by their hashes (e.g., in order of increasing hash value); by their timestamps (e.g., in order of increasing timestamps); by the amount of work needed to confirm the transaction (e.g., based on the amount of cryptographic assets transferred, the vertex's size, etc.); by the amount of stake needed to confirm the transaction; and/or based on any other suitable information. In variants, specifying a transaction execution order can prevent front-running attacks, where miners pick the best order for themselves.

Recording method execution results on the cryptographic network S300 functions to change the blockchain state and/or perform other blockchain actions. The results are preferably recorded (e.g., on the blockchain ledger) by one or more blockchain nodes, but can be otherwise recorded. The results are preferably recorded on the ledger maintained by the cryptographic network (e.g., example shown in FIG. 10), but can additionally or alternatively be recorded off-chain, on-network (e.g., locally stored by the nodes), and/or otherwise recorded. The method execution results can include (e.g., generate): a new blockchain state, an updated set of cryptographic contract parameters (e.g., state, balance, etc.), unspent output (UTXOs), and/or any other suitable set of results.

The new blockchain state can include: the proposed contract state (e.g., accepted or rejected blocks, contract attribute values, whether an external API should be called, etc.), proposed contract balance, input states (e.g., wherein the input UTXOs are spent), new UTXO outputs (e.g., each including an identifier, asset value, recipient address), and/or other values. The new blockchain state can be a result of method evaluation (e.g., such that the blockchain state is changed based on the evaluation), transaction confirmation, block verification, and/or otherwise determined.

In an example, recording the method execution results can include: setting the state variable values to the values computed during method evaluation; updating the cryptographic contract balance; and/or otherwise updating the cryptographic contract parameters. However, the contract parameters can be otherwise updated.

The results are preferably recorded when a transaction is confirmed, but can alternatively be recorded when a transaction is validated, when a block is confirmed (e.g., mined), and/or at any other suitable time. Confirming the transaction can include reaching consensus with a threshold proportion of blocks or blockchain nodes on the new blockchain state, wherein the blockchain state is set to the new blockchain state after confirmation. In an illustrative example, a transaction can be confirmed when a threshold proportion of blockchain nodes independently accept a block that includes the transaction. In another illustrative example, a transaction can be confirmed when a threshold number of blocks has been accepted by a threshold proportion of blockchain nodes after the transaction's block. The threshold proportion of blockchain nodes can include: all blockchain nodes, a majority of blockchain nodes, a quorum of blockchain nodes, a single blockchain node (e.g., wherein the single blockchain node can cryptographically compute a proof that the transaction or related nonce is valid), and/or any other suitable number of blockchain nodes. The transaction, proposed contract state, proposed blockchain state, and/or other information can be propagated to peers in the blockchain using: a gossip protocol, rumor mongering, overlay networks, flooding, content centric networking, and/or other protocols.

The transaction is preferably added to the cryptographic network after it is confirmed. In a first variant, the transaction is added as a vertex in a graph-based network (e.g., added as a vertex in the DAG). Adding the transaction to the graph-based network can include: adding the transaction as a child vertex on a prior transaction in the validation DAG; adding the transaction as a child vertex of the inputs and/or the cryptographic contract in the fund DAG; and/or otherwise adding the transaction to the graph. In a second variant, the transaction is bundled with other transactions within a block, wherein the block is added to the blockchain after confirmation. In a third variant, a verified transaction can be added to a DAG (e.g., of transactions, of verifications, etc.), and a block confirming the transaction (and at least one parent block) can be added to a blockchain related to the DAG.

In a specific example, the transaction can be initially placed in the mempool and remain in the mempool until a block confirms the transaction. The mempool can include multiple transactions all attempting to the spent the same UTXO (e.g., conflicting transactions). In these situations, only one transaction is confirmed by the next block (e.g., the transaction with the highest accumulated weight, etc.); blocks that attempt to confirm more than one conflicting transaction can be deemed invalid and rejected from the network.

In an illustrative example, the method can include, at a node of the cryptographic network: receiving a transaction identifying a contract (or blueprint), a method, a set of method argument values, a set of inputs (e.g., input UTXOs), and a set of outputs (e.g., output UTXOs) from a user; validating the transaction (e.g., using the blockchain client, the core protocol, etc.); adding the validated transaction to the mempool; and during the next consensus (e.g., when the next block is mined), confirming the transaction, including: executing the method of the contract (e.g., using the set of method argument values), optionally generating the set of outputs (e.g., transaction outputs), and adding the transaction to the blockchain. The transaction added to the blockchain can additionally or alternatively be associated with a status of “executed” (e.g., if the contract execution succeeded) or “failed” (e.g., if the contract execution failed). An example is shown in FIG. 9. However, the method can be otherwise performed.

However, the method can be otherwise performed, and the cryptographic contract can be otherwise used.

All references cited herein are incorporated by reference in their entirety, except to the extent that the incorporated material is inconsistent with the express disclosure herein, in which case the language in this disclosure controls.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements (and/or variants thereof) discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A blockchain system, comprising:
a set of contract blueprints, each comprising a set of attributes and a set of methods; and
a set of contracts on a blockchain ledger, wherein each contract comprises an instance of a contract blueprint, wherein executing a method of a contract comprises:
receiving a cryptographic transaction identifying the contract, the method, a set of input unspent transaction outputs (UTXOs), and a set of output UTXOs; and
validating the cryptographic transaction, comprising:
determining logic for the method from the contract blueprint;
executing the logic; and
adding the validated cryptographic transaction to the blockchain ledger.

2. The blockchain system of claim 1, wherein validating the cryptographic transaction further comprises validating the set of input UTXOs and creating the set of output UTXOs.

3. The blockchain system of claim 1, wherein the identifier for the contract comprises a UTXO address.

4. The blockchain system of claim 1, wherein the blockchain ledger comprises a directed acyclic graph (DAG) of transactions, wherein the set of input UTXOs reference the output UTXOs of parent transactions in the DAG of transactions.

5. The blockchain system of claim 1, wherein executing the method of the contract comprises, at each of a set of consensus nodes of the blockchain ledger:
determining a contract state for the contract by executing the method; and
arriving at consensus with a remainder of the set of consensus nodes on the contract state.

6. The blockchain system of claim 1, wherein the set of contract blueprints is stored off-chain.

7. The blockchain system of claim 6, wherein the set of contract blueprints is stored by a client operating a node of the blockchain ledger.

8. The blockchain system of claim 6, wherein a blockchain node validates the cryptographic transaction, wherein the blockchain node determines the logic by retrieving the logic from the contract blueprint stored by the client.

9. The blockchain system of claim 1, wherein a state of the contract is stored as part of a chain state of the blockchain ledger.

10. The blockchain system of claim 1, wherein executing the logic comprises updating a balance of the contract, wherein the balance is stored by a set of nodes of the blockchain.

11. The blockchain system of claim 1, wherein at least one of the set of input UTXOs or the set of output UTXOs comprise custom tokens.

12. A smart contract management method, comprising:
receiving a transaction broadcast to a cryptographic network, the transaction comprising a smart contract address, a method identifier, a set of input unspent transaction output (UTXO) identifiers, and a set of output UTXO identifiers; and
confirming the transaction, comprising:
executing a method, identified by the method identifier, of a smart contract identified by the smart contract address;
changing a state of the smart contract based on the method execution;
validating the set of input UTXOs; and
creating the set of output UTXOs on the cryptographic network.

13. The smart contract management method of claim 12, wherein the state comprises a contract balance.

14. The smart contract management method of claim 12, wherein the smart contract, comprises an instance of a smart contract blueprint comprising a set of blueprint methods, wherein executing the method comprises executing a blueprint method from the smart contract blueprint that is identified by the method identifier.

15. The smart contract management method of claim 14, wherein the smart contract blueprint is stored offchain.

16. The smart contract management method of claim 15, wherein the contract blueprint is stored by a client operating a node in the cryptographic network.

17. The smart contract management method of claim 12, wherein the cryptographic network comprises a directed acyclic graph (DAG) network comprising a DAG of transactions, wherein the transaction is a transaction within the DAG of transactions.

18. The smart contract management method of claim 17, wherein the contract is created by a second transaction within the DAG of transactions.

19. The smart contract management method of claim 17, wherein a transaction in the DAG of transactions references a set of unspent transaction outputs (UTXOs) output by a set of parent transactions in the DAG of transactions.

20. The smart contract management method of claim 17, wherein a child transaction in the DAG of transactions spends unspent transaction outputs (UTXOs) output by parent transactions in the DAG of transactions.
